(19) United States
(12) Patent Application Publication
(10) Pub. No.: US 2015/0249000 A1
(43) Pub. Date: Sep. 3, 2015

(54) INSTRUMENT FOR ANALYSING COMPOUNDS

(71) Applicant: IONICON ANALYTIK GESELLSCHAFT M.B.H, Innsbruck (AT)

(72) Inventors: Philipp Sulzer, Innsbruck (AT); Alfons Jordan, Sellrain (AT); Tilmann Mark, Igls (AT); Lukas Mark, Innsbruck (AT)

(21) Appl. No.: 14/433,177

(22) PCT Filed: Oct. 2, 2013
(86) PCT No.: PCT/EP2013/070539

§ 371 Date: Apr. 2, 2015

(30) Foreign Application Priority Data
Oct. 3, 2012 (EP) 12187098.4

(51) Int. Cl. H01J 49/00; H01J 49/14

(52) U.S. Cl. CPC H01J 49/0072; H01J 49/0031; H01J 49/145

(57) ABSTRACT

Instrument for analysing compounds, comprising an ion source, an adjacent drift tube and a mass spectrometer including an ion detector for separation and detection of product ions, wherein instrumental parameters of the instrument can be altered by actuating elements for actuating variables of at least one of the group consisting of ion source, adjacent drift tube, mass spectrometer and ion detector, characterized by a controlling unit which is connectable to a storage device, wherein the storage device comprises a specification for certain compounds, the specification for each compound comprising a set of data comprising at least two different instrumental parameters and corresponding intensity signals for product ions detected with the ion detector, wherein the controlling unit alters the actuating elements in accordance with the specification for each compound, wherein a correspondence signal is displayed on a display unit if the detected intensity signal for the product ion corresponds with the stored intensity signals.

The present invention relates to an instrument for analysing compounds, comprising at least an ion source, an adjacent drift tube and a mass spectrometer including an ion detector for separation and detection of product ions, wherein instrumental parameters can be altered by actuating elements for actuating variables of at least one of the group consisting of ion source, adjacent drift tube, mass spectrometer and ion detector. Preferably the instrument is a Proton-Transfer-Reaction Mass Spectrometry (PTR-MS) instrument. Further the invention relates to a method of detecting compounds by an instrument comprising at least an ion source, an adjacent drift tube and a mass spectrometer including an ion detector for separation and detection of product ions, wherein instrumental parameters of the instrument are altered by actuating elements for actuating variables of at least one of the group consisting of ion source, adjacent drift tube, mass spectrometer and ion detector.

Proton-Transfer-Reaction Mass Spectrometry (PTR-MS) can still be considered a rather new technology that was originally invented in the 1990s at the Institut für Ionenphysik, Universität Innsbruck (see e.g. DE 195 49 144 A1). One example for an extensive review about the theory and the established fields of application of PTR-MS can be found in J. de Gouw, C. Warneke, T. Karl, G. Eerdekens, C. van der Veen, R. Fall: Measurement of Volatile Organic Compounds in the Earth's Atmosphere using Proton-Transfer-Reaction Mass Spectrometry. Mass Spectrometry Reviews, 26 (2007), 223-257. In short, typical PTR-MS instruments comprise an ion source that produces the reagent ions via e.g. a hollow cathode discharge, an adjacent drift tube for chemical ionization of the analytes and finally a mass spectrometer including an ion detector for separation and detection of the product ions. The main difference between PTR-MS and related technologies, like e.g. Selected-Ion-Flow-Tube Mass Spectrometry (SIFT-MS), is that PTR-MS does not need a mass filter installed between the ion source and the drift tube in order to provide high purity levels of reagent ions. This is only possible because of the sophisticated design of the different PTR-MS components as well as the possibility of tuning an ample number of instrumental parameters by actuating elements:
Gas flow into the ion source, e.g. water vapour via the reagent gas flow controllers (FC_{H2O,O2, . . .} ).
Pressure in the drift tube via the drift tube pressure controller (PC_{drift}).
Hollow cathode discharge current via the source discharge current (Iₛ).
Voltage applied to the drift tube via the drift tube voltage (U_{d}).
Pressure in the ion source via a pump valve (PV) that is interconnected between a pump ring in the ion source and a split-flow turbomolecular pump.
Voltages applied across the ion source for ion extraction via the source voltages (U_{s,so, . . .} ).
Temperatures of the sample gas inlet line and the whole drift tube region via the inlet and drift tube temperatures (T_{inlet,drift})

Methods are described how to generate NO⁺, O₂⁺, Kr⁺, etc. reagent ion currents with high intensity and high purity utilizing such a PTR-MS setup without the need of an additional mass filter between the ion source and the drift tube (see e.g. A. Jordan, S. Haidacher, G. Hanel, E. Hartungen, J. Herbig, L. Märk, R. Schottkowsky, H. Seehauser, P. Sulzer, T. D. Märk: An online ultra-high sensitivity proton-transfer-reaction mass-spectrometer combined with switchable reagent ion capability (PTR+SRI−MS), International Journal of Mass Spectrometry 286 (2009), 32-38; P. Sulzer, A. Jordan, E. Hartungen, T. D. Märk, WO 2012/022772; P. Sulzer, A. Edtbauer, E. Hartungen, S. Jürschik, A. Jordan, G. Hanel, S. Feil, S. Jaksch, L. Märk, T. D. Märk: From conventional Proton-Transfer-Reaction Mass Spectrometry (PTR-MS) to universal trace gas analysis, International Journal of Mass Spectrometry (2012)).

However, the reagent ion used in most applications is H₃O +. Some typical reactions that occur in PTR-MS instruments are:

Proton transfer reactions, either non-dissociative or dissociative, with A being the reagent ion (in most cases H₂O.H⁺) and B and BC being the analyte:

A.H⁺+B→A+B.H⁺ (1)

A.H⁺+BC→A+B+C.H⁺ (2)

Charge transfer reactions, either non-dissociative or dissociative, with A being the reagent ion (e.g. 0₂⁺, NO⁺, Kr⁺, etc.) and B and BC being the analyte:

A⁺+B→A+B⁺ (3)

A⁺+BC→A+B+C⁺ (4)

Clustering reactions, with A being the reagent ion (e.g. H₃O⁺, NO⁺, etc.) and B being the analyte:

A⁺+B→A.B⁺ (5)

In addition other types of reactions occur.

PTR-MS instruments are mainly being used for studies in the fields of environmental chemistry and food & flavour science. However, in the last few years also a series of studies on the application of PTR-MS for the analysis of different threat agents (Chemical Warfare Agents (CWAs), explosives, Toxic Industrial Compounds (TICs) and drugs) was published (F. Petersson, P. Sulzer, C. A. Mayhew, P. Watts, A. Jordan, L. Märk, T. D. Märk: Real-time trace detection and identification of chemical warfare agent simulants using recent advances in proton transfer reaction time-of-flight mass spectrometry, Rapid Commun Mass Spectrom. 23 (2009), 3875-3880; C. A. Mayhew, P. Sulzer, F. Petersson, S. Haidacher, A. Jordan, L. Mark, P. Watts, T. D. Märk: Applications of proton transfer reaction time-of-flight mass spectrometry for the sensitive and rapid real-time detection of solid high explosives, International Journal of Mass Spectrometry 289 (2010), 58-63; S. Jürschik, P. Sulzer, F. Petersson, C. A. Mayhew, A. Jordan, B. Agarwal, S. Haidacher, H. Seehauser, K. Becker, T. D. Märk: Proton transfer reaction mass spectrometry for the sensitive and rapid real-time detection of solid high explosives in air and water, Anal Bioanal Chem 398 (2010), 2813-2820; B. Agarwal, F. Petersson, S. Jürschik, P. Sulzer, A. Jordan, T. D. Märk, P. Watts, C. A. Mayhew: Use of proton transfer reaction time-of-flight mass spectrometry for the analytical detection of illicit and controlled prescription drugs at room temperature via direct headspace sampling, Anal Bioanal Chem (2011) 400, 2631-2639; B. Agarwal, S. Jürschik, P. Sulzer, F. Petersson, S. Jaksch, A. Jordan T. D. Märk: Detection of isocyanates and polychlorinated biphenyls using proton transfer reaction mass spectrometry, Rapid Commun Mass Spectrom., 26 (2012), 983-989; S. Jürschik, B. Agarwal, T. Kassebacher, P. Sulzer, C. A. Mayhew, T. D. Mark: Rapid and facile detection of four “date rape drugs” in different beverages utilizing Proton-Transfer-Reaction Mass Spectrometry (PTR-MS), Journal of Mass Spectrometry (2012) in print. http://dx.doi.org/10.1002/jms.2993; P. Sulzer, F. Petersson, B. Agarwal, K. H. Becker, S. Jürschik, T. D. Märk, D. Perry, P. Watts, C. A. Mayhew: Proton Transfer Reaction Mass Spectrometry and the Unambiguous Real-Time Detection of 2,4,6 Trinitrotoluene, Anal. Chem. (2012)).

All of these studies show, that PTR-MS is extremely sensitive, i.e. all compounds can be readily detected in trace amounts at room temperature and that they can be identified rather unambiguously via the determination of exact masses of the product ions with a time-of-flight based PTR-TOFMS in case they are present in pure form (with only minor impurities) in a clean laboratory environment.

So far all applications and uses of MS instruments describe the instrument as being controlled and the results as being interpreted by an educated scientist or at least a highly skilled person. In detail, the operator has to tune all the instrumental parameters mentioned above prior to the start of a measurement.

Subsequently, a measurement can be performed and the result has then to be interpreted by the skilled operator using profound knowledge of ion chemistry and physics.

Hence, it is an object of the present invention to provide a MS instrument that can be operated by a non-professional operator and where the results can be read without interpretation and without profound knowledge in ion chemistry and physics. A further object is to provide an easy method of operating a MS instrument.

This object is solved by an instrument for analysing compounds, comprising at least an ion source, an adjacent drift tube and a mass spectrometer including an ion detector for separation and detection of product ions, wherein instrumental parameters of the instrument can be altered by actuating elements for actuating variables of at least one of the group consisting of ion source, adjacent drift tube, mass spectrometer and ion detector, that is characterized by a controlling unit which is connectable to a storage device, wherein the storage device comprises a specification for certain compounds, the specification for each compound comprising a set of data comprising at least two different instrumental parameters and corresponding intensity signals for product ions detected with the ion detector, wherein the controlling unit alters the actuating elements in accordance with the specification for each compound, wherein a correspondence signal is displayed on a display unit if the detected intensity signal for the product ion corresponds with the stored intensity signals.

In operating conditions the controlling unit is connected to a storage device. The controlling unit is thus connected to a storage device. The instrument may also comprise the storage device.

The mentioned object is also solved by a method of detecting compounds by an instrument said instrument comprising an ion source, an adjacent drift tube and a mass spectrometer including an ion detector for separation and detection of product ions, wherein instrumental parameters of the instrument are altered by actuating elements for actuating variables of at least one of the group consisting of ion source, adjacent drift tube, mass spectrometer and ion detector, which is characterized by a controlling unit which is connected to a storage device, wherein the storage device comprises a specification for certain compounds, the specification for each compound comprising a set of data comprising at least two different instrumental parameters and corresponding intensity signals for product ions detected with the ion detector, wherein the controlling unit alters the actuating elements in accordance with the specification for each compound, wherein a correspondence signal is displayed on a display unit if the detected intensity signal for the product ion corresponds with the stored intensity signals.

The present invention allows identification of substances at a very high level of confidence without the need of a specially trained human operator. Such an instrument and such a method can be particularly useful in the fields of illicit and/or threat compound detection and virtually everywhere where the presence of distinct substances has to be detected in complex matrices. By using specifications of stored datasets containing known relationships between instrumental parameters that influence the ionisation of the compound and the resulting ionisation pattern of the compound under investigation, it is possible to identify the compound automatically without the need of a specially trained person. Accordingly, the present invention avoids necessity of a skilled operator with a sophisticated knowledge on the alteration of the actuation elements. Hence, the invention transfers an MS instrument from being highly specialized scientific equipment to an easy-to-use substance detector.

In one embodiment of the invention the actuating elements being controlled via actuating variables are selected from the group consisting of
gas flow into the ion source via reagent gas flow controllers (FC _{H2O,O2, . . . ),}
pressure in the drift tube via the drift tube pressure controller (PC_{drift}),
hollow cathode discharge current via the source discharge current (Iₛ),
voltage applied to the drift tube via the drift tube voltage (U_{d}),
pressure in the ion source via a pump valve (PV) that is interconnected between a pump ring in the ion source and a split-flow turbomolecular pump,
voltages applied across the ion source for ion extraction via the source voltages (U_{s,so, . . .} ),
temperatures of the sample gas inlet line and the whole drift tube region via the inlet and drift tube temperatures (T_{inlet,drift}), and
combinations thereof.

One parameter that has a serious influence on whether the reaction is mainly dissociative or non-dissociative is the reduced electric field strength, i.e. the electric field that is applied to the drift tube divided by the particle number density (E/N). Although being determined by various parameters (pressure, temperature, etc.) the E/N can be adjusted very fast and easy by changing the voltage applied to the drift tube. Hence, in a preferred embodiment the actuating element being altered is at least the voltage applied to the drift tube.

As noted the instrument does not need a mass filter in order to provide high purity levels of reagent ions so it is preferred that the instrument does not comprise a mass filter installed between the ion source and the drift tube. Hence, in a particularly preferred embodiment the instrument is a Proton-Transfer-Reaction Mass Spectrometry (PTR-MS) instrument.

In an embodiment of the invention the instrument for analysing compounds consists of an ion source, an adjacent drift tube and a mass spectrometer including an ion detector for separation and detection of product ions, the controlling unit, vacuum devices and valves and the storage device. In this embodiment no further devices are present in the instrument.

The controlling unit can either be software based running on an already existing controlling hardware or an electronic module built in a way that it can read and set all relevant instrumental parameters and data such as a programmable controller.

In a preferred embodiment the storage device comprises a database wherein the specification of each compound is stored. The storage device may be either an internal storage such as a hard disk, an external device which is connected by a network or a combination of external and internal storage. In the later case it is possible to operate the PTR-MS instrument offline but to update the database from time to time.

In order to control the pressure conditions in the instrument first of all at least one vacuum device such as a vacuum pump should be present in the instrument. Said vacuum device should be implemented in such a way that the pressure in the ion source, the drift tube and the mass spectrometer may be reduced. Next the final pressure in any of these devices is preferably regulated by pressure controllers, valves or pump valves. Different vacuum conditions in the ion source, the drift tube and/or the mass spectrometer may be used in order to control ionisation and thus vacuum device and valve controls may be used as actuating variables.

Further advantages and details of the invention are shown in the figures and the description of the figures.

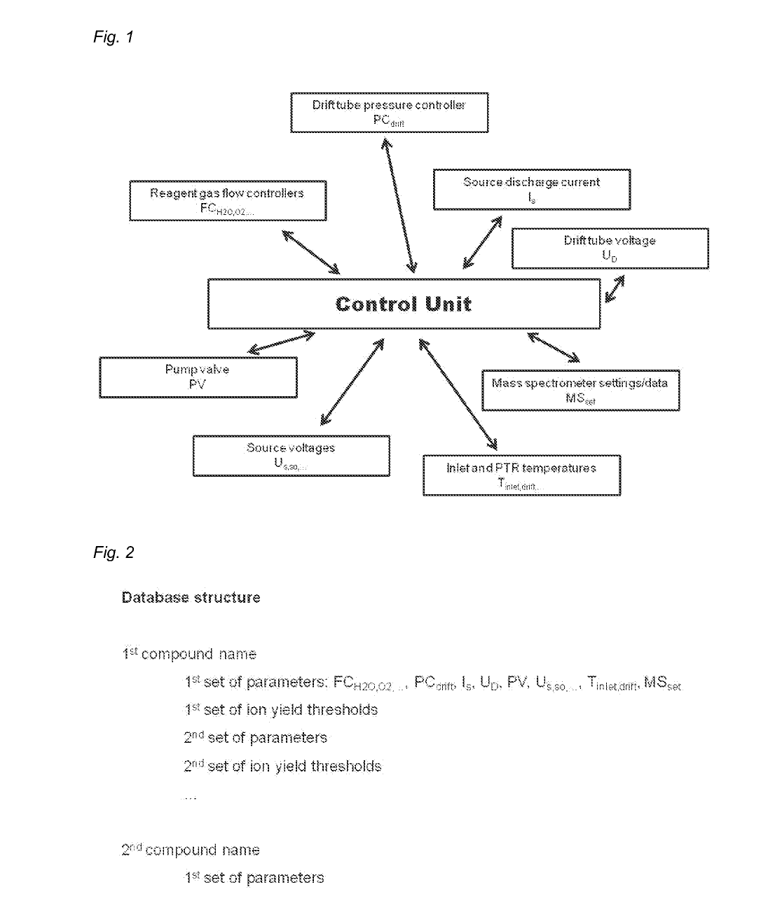

FIG. 1 shows a schematic overview of a controlling unit of an instrument for analysing compounds that is fed by a storage device.

FIG. 2 shows the structure of a storage device in form of a database.

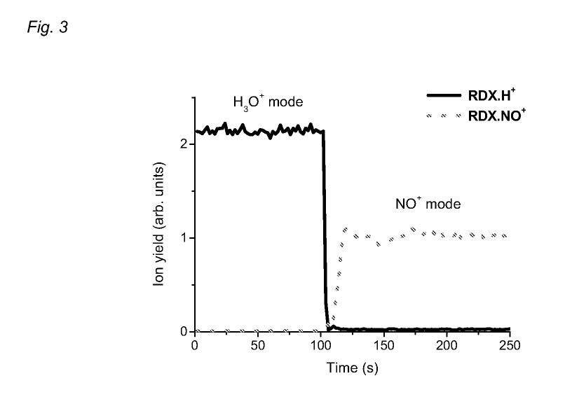

FIG. 3 shows ion yields corresponding to masses (m/z values) of RDX.H⁺ (solid line) and RDX.NO⁺ (dotted line).

FIG. 1 displays a schematic overview of the functional principle of the controlling unit of an instrument for analysing compounds in the form of a PTR-MS instrument that is fed by a storage device which contains a database that can be structured as shown in FIG. 2. The controlling unit controls several instrumental parameters therefore altering actuating elements for actuating variables. Possible actuating variables are selected from the group consisting of
gas flow into the ion source via reagent gas flow controllers (FC_{H2O,O2, . . . ),}
pressure in the drift tube via the drift tube pressure controller (PC_{drift}),
hollow cathode discharge current via the source discharge current (Iₛ),
voltage applied to the drift tube via the drift tube voltage (U_{d}),
pressure in the ion source via a pump valve (PV) that is interconnected between a pump ring in the ion source and a split-flow turbomolecular pump,
voltages applied across the ion source for ion extraction via the source voltages (U_{s,so, . . .} ),
temperatures of the sample gas inlet line and the whole drift tube region via the inlet and drift tube temperatures (T_{inlet,drift}).
Any combination of these actuating variables is of course also possible.

In practice the controlling unit reads the specification of the first compound name from the database, writes the first set of instrumental parameters to the PTR-MS instrument and checks via feedback from the different components (readouts) if the actuating element have been set correctly via the actuating variables. Subsequently the controlling unit acquires the ion yields corresponding to the m/z values in the first set of ion yield thresholds from the mass spectrometer and compares it with the thresholds stored in the storage unit. In case the obtained values are below the thresholds the compound is automatically considered as being “not detected” and the controlling unit jumps to the next compound specification in the database.

In case the obtained values are above the threshold the controlling unit proceeds to the second set of parameters. This process is repeated until no more sets of parameters/ion yield thresholds are available for the compound. That is that the specification of the molecule has been tested. If this point is reached (i.e. all thresholds have been exceeded) the controlling unit considers the compound as “detected”. In case there are no more compound entries in the database the Control Unit starts all over with the first database entry.

This functional principle works for a wide range of substances and is not limited to threat agents (explosives, CWAs, TICs, drugs). The storage device entries can be either compiled from existing publications on PTR-MS studies of the compounds of interest or be created by using the PTR-MS instrument in the conventional way, i.e. a skilled user analyzes the substances manually and processes the data in a way that a database entry can be created.

In the following two practical examples for database entries are shown that should not be understood as a limitation of the concept to these two compounds, but as a proof-of-principle.

### EXAMPLE 1

Trinitrotoluene (TNT; C₇H₅N₃O₆) as one of the most commonly known explosives shows a rather unique E/N behavior, i.e. the ion yield on the m/z ratio of the protonated TNT parent ion decreases with decreasing E/N in a certain range. Furthermore, upon proton transfer from H₃O⁺ TNT yields mainly TNT.H⁺, whereas under chemical ionization from O₂⁺ it yields mainly (TNT-OH)⁺.

Therefore the first set of parameters should be in a way that the ion source efficiently produces H₃O⁺ at good purity (over 90%) and that the E/N ratio is set to 90-100 Td (Townsend), which typically corresponds to about 400 V drift tube voltage at about 100° C. drift tube temperature and 2.3 mbar drift tube pressure.

The first set of thresholds should be set for nominal mass 228 m/z (or the exact mass of protonated TNT if the resolution of the mass spectrometer is sufficient) according to the expected detection sensitivity (typically between 10 and 100 cps (counts-per-second) threshold). The second set of parameters should be identical to the previous one except for the E/N ratio being set to 170-180 Td (typically 700V drift tube voltage).

The second set of thresholds should be set for nominal mass 228 m/z (or the exact mass of protonated TNT if the resolution of the mass spectrometer is sufficient) to a value about seven times higher than the threshold for 90-100 Td, as the ion yield increases with increasing E/N for TNT. The third set of parameters should be in a way that the ion source efficiently produces O₂⁺ at high purity (over 70%), the O₂⁺ intensity is comparable to H₃O⁺ in the previous step and the E/N ratio is between 110-130 Td.

The third set of thresholds should be set for nominal mass 210 m/z (or the exact mass of (TNT-OH)⁺ if the resolution of the mass spectrometer is sufficient) to about the same value as for the second set (i.e. seven times higher than the first set).

If all three thresholds are exceeded the Control Unit considers TNT as identified.

### EXAMPLE 2

Hexogen (RDX; C₃H₆N₆O₆) is another commonly used solid explosive. Its E/N behavior is completely opposite to TNT, i.e. the ion yield on the protonated RDX parent ion mass decreases with increasing E/N over a certain range. For H₃O⁺ mode RDX yields RDX.H⁺, in NO⁺ mode RDX yields RDX.NO⁺, which is presented in form of actual and unpublished measurement data in FIG. 3.

The first set of parameters should be in a way that the ion source efficiently produces H₃O⁺ at good purity (over 90%) and that the E/N ratio is set to 170-180 Td (Townsend), which typically corresponds to about 700 V drift tube voltage at about 100° C. drift tube temperature and 2.3 mbar drift tube pressure.

The first set of thresholds should be set for nominal mass 223 m/z (or the exact mass of protonated RDX if the resolution of the mass spectrometer is sufficient) according to the expected detection sensitivity (typically between 1 and 10 cps (counts-per-second) threshold).

The second set of parameters should be identical to the previous one except for the E/N ratio being set to 90-100 Td (typically 400 V drift tube voltage).

The second set of thresholds should be set for nominal mass 223 m/z (or the exact mass of protonated RDX if the resolution of the mass spectrometer is sufficient) to a value about five times higher than the threshold for 170-180 Td, as the ion yield increases with decreasing E/N for RDX.

The third set of parameters should be in a way that the ion source efficiently produces 0₂⁺ at high purity (over 70%), the NO intensity is comparable to H₃O⁺ in the previous step and the E/N ratio is between 90-100 Td.

The third set of thresholds should be set for nominal mass 252 m/z (or the exact mass of (RDX.NO)⁺ if the resolution of the mass spectrometer is sufficient) to about the half value as for the second set.

If all three thresholds are exceeded the Control Unit considers RDX as identified.

FIG. 3 shows the ion yields corresponding to the masses (m/z values) of RDX.H⁺ (solid line) and RDX.NO⁺ (dotted line). At the beginning the instrument is operated in H₃O⁺ (reagent ion) mode, after about 100 s it is switched to NO mode. According to this measurement virtually no signal is present on the m/z corresponding to RDX.NO⁺ in H₃O⁺ mode, whereas in NO⁺ mode virtually no signal is present on the mass (m/z) corresponding to RDX.H⁺, i.e. if only these two m/z values are monitored, RDX yields solely on the m/z corresponding to RDX.H⁺ in H₃O⁺ mode and on the m/z corresponding to RDX.NO⁺ in NO mode. This result can be used for the identification of RDX, as other compounds, even in case they possess the same nominal mass, are not expected to show the same behavior.

1. Instrument for analysing compounds, comprising
at least an ion source,
an adjacent drift tube and
a mass spectrometer including an ion detector for separation and detection of product ions,
wherein instrumental parameters can be altered by actuating elements for actuating variables of at least one of the group consisting of ion source, adjacent drift tube, mass spectrometer and ion detector,
further comprising a controlling unit which is connectable to a storage device,
wherein the storage device comprises a specification for certain compounds, the specification for each compound comprising a set of data comprising at least two different instrumental parameters and corresponding intensity signals for product ions detected with the ion detector,
wherein the controlling unit alters the actuating elements in accordance with the specification for each compound,
wherein a correspondence signal is displayed on a display unit if the detected intensity signal for the product ion corresponds with the stored intensity signals.

2. Instrument according to claim 1, wherein the actuating elements being controlled via actuating variables are selected from the group consisting of
gas flow into the ion source via reagent gas flow controllers (FC_{H2O,O2, . . .} ),
pressure in the drift tube via the drift tube pressure controller (PC_{drift}),
hollow cathode discharge current via the source discharge current (Iₛ),
voltage applied to the drift tube via the drift tube voltage (U_{d}),
pressure in the ion source via a pump valve (PV) that is interconnected between a pump ring in the ion source and a split-flow turbomolecular pump,
voltages applied across the ion source for ion extraction via the source voltages (U_{s,so, . . .} ),
temperatures of the sample gas inlet line and the whole drift tube region via the inlet and drift tube temperatures (T_{inlet,drift}), and
combinations thereof.

3. Instrument according to claim 1, wherein the actuating element being altered is at least the voltage applied to the drift tube.

4. Instrument according to claim 1, wherein the storage device comprises a database wherein the specification of each compound is stored.

5. Instrument according to claim 4, wherein the storage device is an internal storage, an external device or a combination of external and internal storage.

6. Instrument according to claim 1 in which the instrument is a Proton-Transfer-Reaction Mass Spectrometry (PTR-MS) instrument.

7. A method of detecting compounds by an instrument comprising
at least an ion source,
an adjacent drift tube and
a mass spectrometer including an ion detector for separation and detection of product ions,
wherein instrumental parameters of the instrument are altered by actuating elements for actuating variables of at least one of the group consisting of ion source, adjacent drift tube, mass spectrometer and ion detector,
further comprising a controlling unit which is connected to a storage device,
wherein the storage device comprises a specification for certain compounds, the specification for each compound comprising a set of data comprising at least two different instrumental parameters and corresponding intensity signals for product ions detected with the ion detector,
wherein the controlling unit alters the actuating elements in accordance with the specification for each compound,
wherein a correspondence signal is displayed on a display unit if the detected intensity signal for the product ion corresponds with the stored intensity signals.
